(19) United States
(12) Patent Application Publication
(10) Pub. No.: US 2015/0193562 A1
(43) Pub. Date: Jul. 9, 2015

(54) METHOD AND APPARATUS FOR COMPUTER GENERATION OF A GEOMETRIC LAYOUT REPRESENTING A CENTRAL ISLAND OF A TRAFFIC ROUNDABOUT

(71) Applicants: Steven Chi Kit Chan, Richmond (CA); Darren Earl Brown, Burnaby (CA)

(72) Inventors: Steven Chi Kit Chan, Richmond (CA); Darren Earl Brown, Burnaby (CA)

(73) Assignee: Transoft Solutions, Inc., Richmond, BC (CA)

(21) Appl. No.: 14/408,510

(22) PCT Filed: Jun. 20, 2012
(86) PCT No.: PCT/CA2012/000606

§ 371 Date: Dec. 16, 2014

(51) Int. Cl. G06F 17/50; E01C 1/02; E01C 1/00

(52) U.S. Cl. CPC G06F 17/5004; E01C 1/002; E01C 1/02

(57) ABSTRACT

A method, apparatus and computer readable medium for computer generation of a geometric layout representing a central island of a traffic roundabout is disclosed. The method involves generating a vehicle path associated with travel of a vehicle through the roundabout, generating vehicle extent locations associated with travel of the vehicle along the vehicle path, using the vehicle extent locations to determine a geometric layout of the central island corresponding to the vehicle extents, and generating output data representing the geometric layout of the central island.

### BACKGROUND OF THE INVENTION

1. Field of Invention

This invention relates generally to traffic intersections and more particularly to computer generation of a geometric layout of a central island of a traffic roundabout.

2. Description of Related Art

Traffic intersections such as roundabouts may be designed by laying out the roadways and intersection area on a computer using a computer aided design (CAD) application. A traffic roundabout is a particular type of traffic intersection having a central island surrounded by a circulatory roadway and having one or more approach roadways. The circulatory roadway includes at least one lane and should be sized to provide for adequate maneuvering space for different vehicles that will use the intersection. A designer of a roundabout will generally take into account a defined design vehicle that is expected to use the roundabout and may also face other constraints that should be satisfied.

Most roundabout designs proceed on the basis of a circular central island, which may further include an annular truck apron surrounding the central island. The truck apron is a mountable portion of the central island for facilitating passage of larger vehicles through the intersection that would typically encroach on the central island. The apron may be differentiated from the circulatory roadway by painted markings, a height differential, or through the use of different paving material, for example. In some instances, departures from a circular shaped central island and/or apron may be provided by extending the central island in one direction, such that the final shape of the central island becomes non-circular.

There remains a need for improved methods for generating the geometric layout of the central island of a roundabout or other circular traffic intersection.

### SUMMARY OF THE INVENTION

In accordance with one aspect of the invention there is provided a method for computer generation of a geometric layout representing a central island of a traffic roundabout. The method involves generating a vehicle path associated with travel of a vehicle through the roundabout, generating vehicle extent locations associated with travel of the vehicle along the vehicle path, using the vehicle extent locations to determine a geometric layout of the central island corresponding to the vehicle extents, and generating output data representing the geometric layout of the central island.

The roundabout includes at least two adjacent lanes extending through at least a portion of the roundabout and generating the vehicle path may involve generating a vehicle path associated with travel of a vehicle through the roundabout while making a lane change from a first lane to a second lane of the at least two adjacent lanes.

The roundabout may include at least two adjacent circulatory lanes and at least two corresponding entry lanes associated with an approach to the roundabout, and generating the vehicle path may involve generating a vehicle path associated with travel of the vehicle through the roundabout while making a lane change from a first entry lane to a second circulatory lane.

The roundabout may include at least two adjacent circulatory lanes and generating the vehicle path may involve generating a vehicle path associated with travel of the vehicle through the roundabout while making a lane change from the first circulatory lane to the second circulatory lane.

Generating the vehicle path may involve generating a first path portion representing travel of the vehicle along the first lane, generating a second path portion representing travel of the vehicle along the second lane, and generating a lane change path extending between the first path portion and the second path portion.

Generating the lane change path may involve generating a spiral path extending between the first path portion and the second path portion.

Generating the spiral path may involve generating a spiral path between a start point on the first path portion and an end point on the second path portion.

The method may involve receiving operator input of the start point and the end point.

The start point and end point may be each defined by an intersection of a line with the respective first and second path portions, the line extending outwardly from an origin point on the central island.

The origin point on the central island may include a center point of the central island.

The method may involve constraining the start point and the end point to fall between a first boundary angle and a second boundary angle, each of the first and second boundary angles being defined by a line extending outwardly from an origin point on the central island.

The origin point on the central island may include a center point of the central island.

Generating the first path portion may involve generating a first circulatory path associated with travel of the vehicle along the first lane, the first path portion including a portion of the first circulatory path, and generating the second path portion may involve generating a second circulatory path associated with travel of the vehicle along the second lane, the second path portion including a portion of the second circulatory path, and the first boundary angle may correspond to a location of a point on the first circulatory path at which an entry path associated with a vehicle entering the roundabout along an entry lane of the roundabout intersects with the first circulatory path, and the second boundary angle may correspond to a location of a point on the second circulatory path with respect to the origin point at which travel of a vehicle exiting the roundabout along an exit lane of the roundabout leaves the second circulatory path.

The method may involve constraining a location of the start point such that the vehicle traveling along the lane change path would not interfere with another vehicle traveling along the second lane and exiting the roundabout at another exit lane of the roundabout disposed before the exit being used by the vehicle traveling along the lane change path.

Generating the spiral path may involve generating a plurality of spiral paths having different rates of change of radii and selecting one of the plurality of spiral paths that has a generally tangential intersection with the first path portion proximate a start point associated with the lane change and with the second path portion proximate an end point associated with the lane change.

Generating the spiral path may involve generating a plurality of spiral paths having different rates of change of radii and extending tangentially from an end point on the second path portion and selecting one of the plurality of spiral paths that intersects a line drawn tangent to the first path portion at a start point on the first path portion.

Generating the plurality of spiral paths may involve generating spiral paths by representing the vehicle using a design vehicle, moving the design vehicle backwards through the roundabout from the end point on the second path portion, and varying a steering rate of the design vehicle to generate the respective spiral paths in the plurality of spiral paths.

Varying the steering rate of the design vehicle may involve varying the steering rate over a range of steering rates associated with the design vehicle traveling through the roundabout at a design speed.

The method may involve receiving operator input of the design speed.

Generating the vehicle path may further involve generating an exit path associated with travel of the vehicle between the second path portion and an exit lane of the roundabout.

Generating the vehicle path may further involve generating an entry path associated with travel of the vehicle between an entry lane of the roundabout and the first path portion.

The method may involve receiving an operator selection of at least one of an entry lane, a starting lane, an ending lane, and an exit lane for the lane change.

The central island may be initially constructed as a circular central island and using the vehicle extent locations to determine a geometric layout of the central island may involve using the vehicle extents to generate modifications to the circular island resulting in a non-circular island geometry.

Using the vehicle extent locations to determine a geometric layout of the central island may involve offsetting the vehicle extent locations by an offset distance to provide a clearance allowance for the vehicle travelling along the vehicle path.

Generating the vehicle path may further involve generating an exit path associated with travel of the vehicle between the vehicle path and an exit lane of the roundabout.

Generating the vehicle path may further involve generating an entry path associated with travel of the vehicle between an entry lane of the roundabout and the vehicle path.

Using the vehicle extent locations to determine the geometric layout of the central island may involve at least one of determining a physical curb location associated with the geometric layout of the central island, determining a shape and extent of an extension to the central island to be indicated by marking the pavement of the roundabout, and determining a shape and extent of an apron to facilitate passage of oversize vehicles by permitting the oversize vehicles to encroach on the apron.

The central island may be initially constructed as a circular central island and using the vehicle extent locations to determine a geometric layout of the central island may involve using the vehicle extents to generate modifications to the circular island resulting in a non-circular island geometry.

Using the vehicle extent locations to determine a geometric layout of the central island may involve offsetting the vehicle extent locations by an offset distance to provide a clearance allowance for the vehicle travelling along the vehicle path.

The method may involve receiving an initial geometric layout representing the traffic roundabout and central island, the initial geometric layout having been generated for a first design vehicle, and generating the vehicle path associated with travel of the vehicle through the roundabout may involve generating a vehicle path associated with travel of a second design vehicle through the roundabout, the second design vehicle requiring a reduction in the extent of the central island to facilitate passage through the roundabout.

The first design vehicle may involve a first set of design vehicles.

In accordance with another aspect of the invention there is provided an apparatus for facilitating computer generation of a geometric layout representing a central island of a traffic roundabout. The apparatus includes provisions for generating a vehicle path associated with travel of a vehicle through the roundabout, provisions for generating vehicle extent locations associated with travel of the vehicle along the vehicle path, provisions for using the vehicle extent locations to determine a geometric layout of the central island corresponding to the vehicle extents, and provisions for generating output data representing the geometric layout of the central island.

In accordance with another aspect of the invention there is provided an apparatus for facilitating computer generation of a geometric layout representing a central island of a traffic roundabout. The apparatus includes a processor circuit operably configured to generate a vehicle path associated with travel of a vehicle through the roundabout, generate vehicle extent locations associated with travel of the vehicle along the vehicle path, use the vehicle extent locations to determine a geometric layout of the central island corresponding to the vehicle extents, and generate output data representing the geometric layout of the central island.

In accordance with another aspect of the invention there is provided a computer readable medium encoded with codes for directing a processor circuit to facilitate computer generation of a geometric layout representing a central island of a traffic roundabout. The computer readable medium including codes for generating a vehicle path associated with travel of a vehicle through the roundabout, generating vehicle extent locations associated with travel of the vehicle along the vehicle path, using the vehicle extent locations to determine a geometric layout of the central island corresponding to the vehicle extents, and generating output data representing the geometric layout of the central island.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a block diagram of an apparatus for generating a geometric layout representing a central island of a roundabout;

FIG. 2 is a processor circuit embodiment for implementing the apparatus shown in FIG. 1;

FIG. 3 is an initial layout of a traffic roundabout generated by the apparatus shown in FIG. 1;

FIG. 4 is a geometric layout of the roundabout shown in FIG. 3 in accordance with one embodiment of the invention;

FIG. 5 is a flowchart depicting blocks of code for implementing a process for generating the geometric layout of the central island on the processor circuit shown in FIG. 2;

FIG. 6 is a top schematic view of a WB-50 semi-trailer design vehicle and a corresponding bicycle model for representing the vehicle;

FIG. 7 is a table listing parameters for standard design vehicles;

FIG. 8 is a flowchart depicting blocks of code for implementing a process for generating a vehicle path;

FIG. 9 is a flowchart depicting blocks of code for implementing a process for generating vehicle extent locations;

FIG. 10 is a portion of the vehicle path generated in accordance with the process of FIG. 8;

FIG. 11 is a flowchart depicting blocks of code for implementing a process for generating a geometric layout of the central island is shown at 1100

FIG. 12 is a geometric layout of a roundabout including two adjacent circulatory lanes in accordance with an alternative embodiment of the invention;

FIG. 13 is a flowchart depicting blocks of code for implementing a process for generating a vehicle path for the layout of the roundabout shown in FIG. 12;

FIG. 14 is a screenshot of an operator input window for receiving operator input;

FIG. 15 is an enlarged view of a vehicle path associated with the layout shown in FIG. 12;

FIG. 16 is a flowchart depicting blocks of code for implementing a lane change portion of the process shown in FIG. 13;

FIG. 17 is a schematic view of a plurality of lane change spiral paths; and

FIG. 18 is a geometric layout of a roundabout in accordance with another embodiment of the invention.

### DETAILED DESCRIPTION

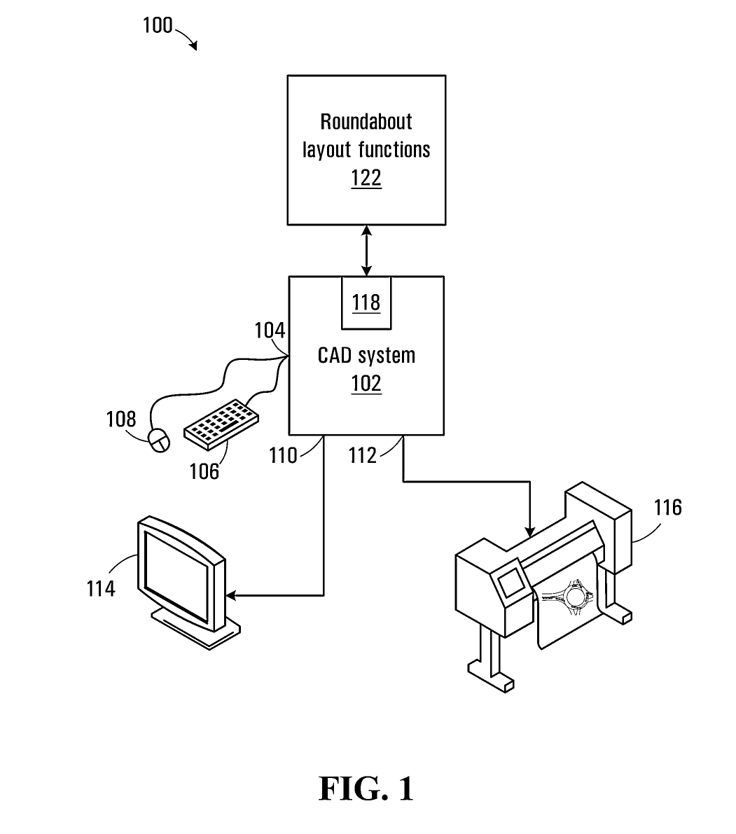

Referring to FIG. 1, a block diagram of an apparatus for generating a geometric layout representing a central island of a roundabout is shown generally at 100. The apparatus 100 includes a CAD system 102 having an input 104 for receiving operator input from an input device such as a keyboard 106 and/or a pointing device 108. The pointing device 108 may be a computer mouse, trackball, or digitizing tablet, or other device operable to produce pointer movement signals. The CAD system 102 also includes a display 114 and an output 110 for producing output data for displaying an image of the geometric layout on the display. The CAD system 102 further includes a plotter 116 and an output 112 for producing output data for causing the plotter to print a hardcopy representation of the geometric layout.

The CAD system 102 also includes an interface 118 that provides access to the CAD system functions implemented by the CAD system 102. The apparatus 100 further includes a roundabout layout functional block 122, which provides functions for causing the CAD system 102 to generate the geometric layout of the roundabout. The roundabout functional block 122 interfaces with the CAD system through the interface 118.

The CAD system may be provided by causing a computer to execute CAD system software such as the AutoCAD® software application available from Autodesk Inc. of San Rafael, Calif., USA. AutoCAD provides drawing elements such as lines, polylines, circles, arcs, and other complex elements. Customization of AutoCAD is provided through ObjectARX (AutoCAD Runtime Extension), which is an application programming interface (API) that permits access to a class-based model of AutoCAD drawing elements. Customization code may be written in a programming language such as C⁺⁺, which may be compiled to provide the functionality represented as the roundabout layout functional block 122.

Other CAD systems, such as MicroStation sold by Bentley Systems Inc. of Exton, Pa., USA, provide similar CAD functionality and interfaces for customization. Advantageously, using existing CAD software applications to provide standard CAD functionality allows operators to produce drawing files representing the roundabout using a familiar software application. The resulting drawing files may also be saved in such a manner to permit other operators who do not have access to the roundabout functional block 122, to view and/or edit the drawings.

### Processor Circuit

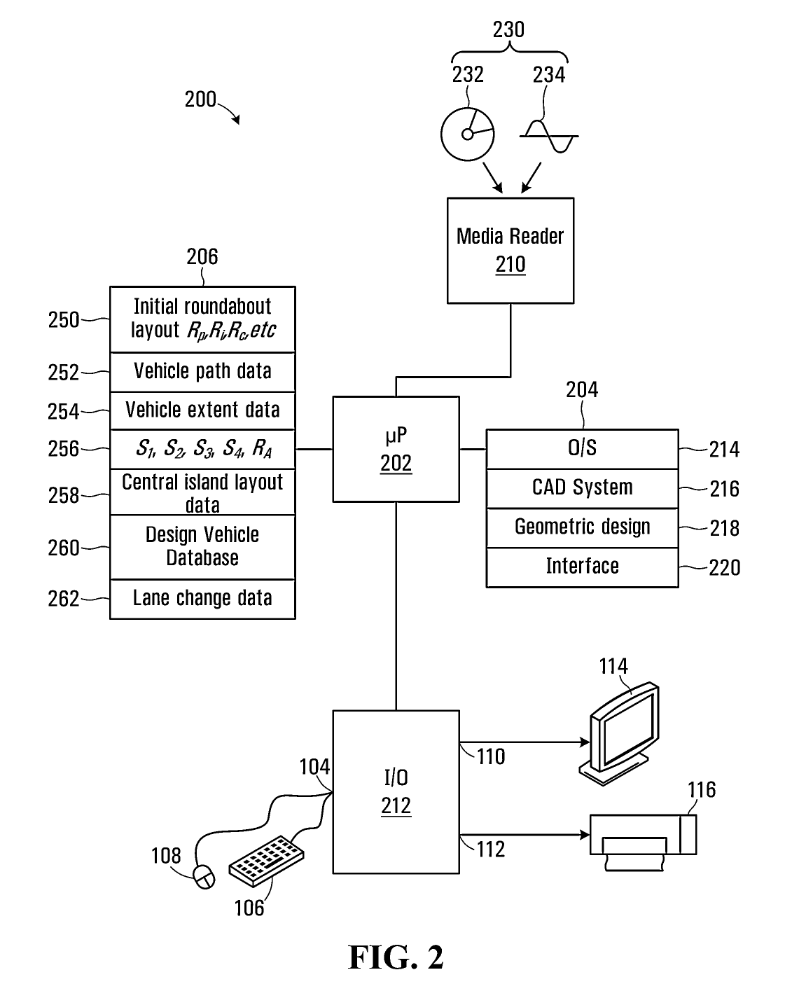

Referring to FIG. 2, a processor circuit embodiment for implementing the apparatus 100 (shown in FIG. 1) is shown generally at 200. The processor circuit 200 includes a microprocessor 202, a program memory 204, a variable memory 206, a media reader 210, and an input output port (I/O) 212, all of which are in communication with the microprocessor 202.

Program codes for directing the microprocessor 202 to carry out various functions are stored in the program memory 204, which may be implemented as a random access memory (RAM) and/or a hard disk drive (HDD), or a combination thereof. The program memory 204 includes a first block of program codes 214 for directing the microprocessor 202 to perform operating system functions and a second block of program codes 216 for directing the microprocessor 202 to perform CAD system functions for implementing the CAD system 102 shown in FIG. 1. The program memory 204 also includes a third block of program codes 218 for directing the microprocessor 202 to perform roundabout geometric layout functions and a fourth block of program codes 220 for directing the microprocessor 202 to provide an interface between the CAD functions and the roundabout geometric layout functions.

The media reader 210 facilitates loading program codes into the program memory 204 from a computer readable medium 230, such as a CD ROM disk 232, or a computer readable signal 234, such as may be received over a network such as the internet, for example.

The I/O 212 includes the input 104 for receiving operator input from the keyboard 106 and pointing device 108. The I/O 212 further includes the outputs 110 and 112 for producing output data for driving the display 114 and plotter 116.

The variable memory 206 includes a plurality of storage locations including a location 250 for storing an initial roundabout layout, a location 252 for storing a vehicle path data, a location 254 for storing vehicle extent data, a location 256 for storing clearance allowance offsets and approach radii, a location 258 for storing a central island layout, a location 260 for storing a design vehicle database, and a location 262 for storing lane change data. The variable memory 206 may be implemented as a hard drive, for example.

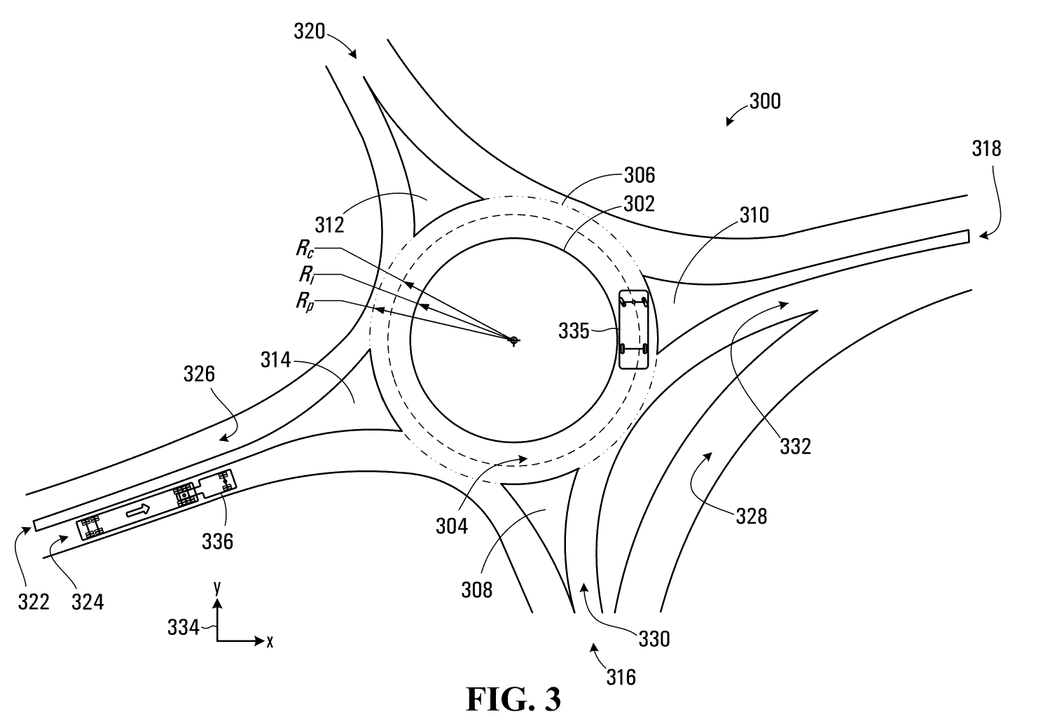

Referring to FIG. 3, an initial layout 300 of a traffic roundabout is shown generally at 300. In this embodiment, the initial layout 300 includes a circular central island 302 surrounded by a circulatory lane 304. In other embodiments an initial shape of the central island may be elliptical, oval, or an irregular shape, or in some embodiments the central island may be initially omitted and generated by the methods disclosed herein. For convenience, in the embodiments described below, the shape of the central island will be assumed to be initially circular. The circulatory lane 304 extends between the central island 302 and an outer perimeter 306. The initial layout 300 also includes a plurality of approach roadways 316, 318, 320, and 322, which in this embodiment each include an entry lane and an exit lane. For example, the approach roadway 322 includes an entry lane 324 and an exit lane 326, the approach roadway 316 includes two entry lanes 328 and 330, and the approach roadway 318 includes two exit lanes 332 and the lane 328, which in this embodiment bypasses the circulatory lane 304. The approach roadway 320 includes an exit lane 340 and an entrance lane 342. In this embodiment the outer perimeter 306 is used to define portions of a plurality of splitter islands 308, 310, 312, and 314 that bound the circulatory lane 304 and also to divide the respective approach roadways 316-322 into entry and exit lanes.

The elements making up the initial layout 300 of the roundabout shown in FIG. 3 are defined by coordinates in an x-y Cartesian coordinate system 334. In the embodiment shown an orientation of each of the plurality of approach roadways 316, 318, 320, and 322 in the x-y Cartesian coordinate system 334 is defined by a corresponding reference line 422, 424, 426, and 428. In other embodiments, the approach roadways may comprise only an exit lane or only an entry lane or may comprise more than one entry and/or exit lane. Similarly the circulatory lane 304 may include more than one lane for accommodating side-by-side traffic flow through the roundabout.

The initial layout 300 may have been previously generated by the apparatus 100. As such, a radius of the circular central island 302 and a radius of the outer perimeter 306 may have already been established to accommodate passage of a vehicle 335 through the roundabout on the circulatory lane 304. For example, the apparatus 100 may be configured to provide the functionality as described in commonly owned PCT patent publication WO 2010/06018002098, filed on Nov. 26, 2008, which is incorporated herein by reference in its entirety. In other embodiments the initial layout 300 may have been determined by manual calculation or other methods and may be received through user input at the input 104 of the I/O 212, or read in by the media reader 210 from a CD ROM disk 232 or computer readable signal 234, for example. Data defining the initial layout 300 is stored in the location 250 of the variable memory 206 shown in FIG. 2. For example dimensions such as a radius Rₚ of the outer perimeter 306 and a radius Rᵢ of the circular central island 302 may be stored in the location 250 along with coordinates of reference lines 422-428 defining the orientation of the plurality of approach roadways 316-322.

In some cases it may be desirable to further accommodate passage of a larger vehicle than the vehicle 335 through the intersection. For example, a semi-trailer vehicle such as that shown at 336 would not be able to move through the roundabout shown in FIG. 3 without encroaching on the circular central island 302 and/or one or more of the splitter islands 308-314.

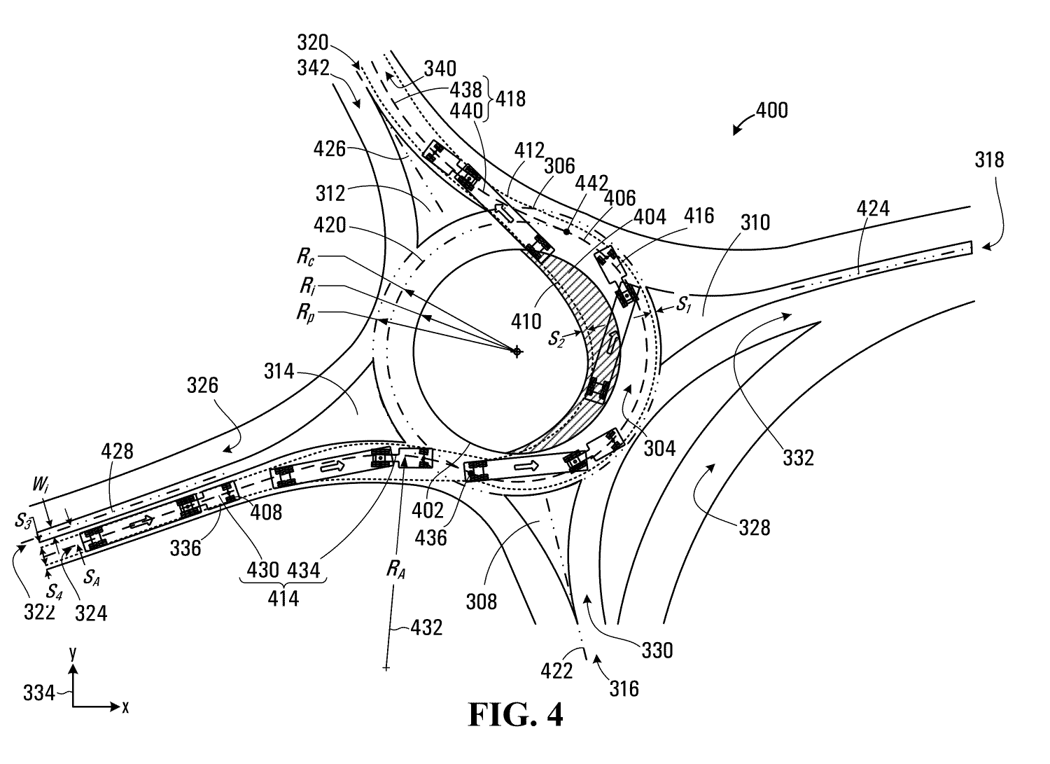

Referring to FIG. 4, a geometric layout of the roundabout of FIG. 3 in accordance with a first embodiment of the invention is shown at 400. The circular central island 302 of the initial layout 300 in FIG. 3 has been modified to generate a non-circular central island 402 by removing a portion 404 of the circular central island 302. The modifications to the central island 302 result in the non-circular central island 402 to facilitate passage of the vehicle 336 through the roundabout.

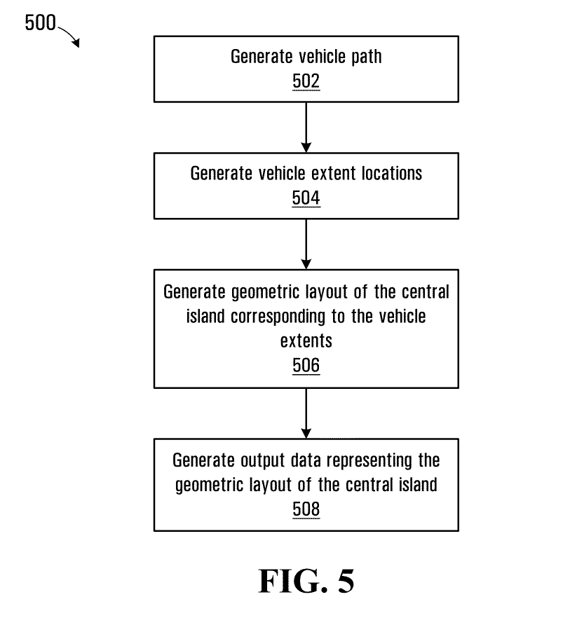

Referring to FIG. 5 a flowchart depicting blocks of code for directing the processor circuit 200 (shown in FIG. 2) to implement a process for generating a geometric layout representing a central island of a traffic roundabout is shown generally at 500. The blocks generally represent codes that may be read from the computer readable medium 230, and stored in the program memory 204, for directing the microprocessor 202 to perform various functions related to generating the central island layout. The actual code to implement each block may be written in any suitable program language, such as C⁺⁺, for example.

The process begins at block 502, which directs the microprocessor 202 to generate a vehicle path 406 for the vehicle 336 to follow through the roundabout. The vehicle 336 includes steerable front wheels 408 and in this embodiment front wheels are steered such that a reference location on the vehicle at the center of an axle associated with the front wheels follows the vehicle path through the roundabout. In other embodiments alternative reference locations on the vehicle may be selected, such as a protruding point on a wide load or other protruding vehicle feature that would need clearance from curbs, walls, barriers, or other structures associated with the roundabout. Block 502 also directs the microprocessor 202 to store coordinates for the vehicle path 406 in the location 252 of the variable memory 206.

Block 504 then directs the microprocessor 202 to generate vehicle extent locations associated with travel of the vehicle along the vehicle path 406. In FIG. 4, the vehicle extent locations are represented by broken lines 410 and 412. The vehicle extent line 410 represents inner vehicle extents and vehicle extent line 412 represents outer vehicle extents. In general the vehicle extents 410 and 412 are generated for portions or the vehicle 336 that would need to clear a curb associated with the central island 402 or any of the splitter islands 308-312 or any other obstacle located at sufficient height to impede passage of the vehicle. Block 504 further directs the microprocessor 202 to store coordinates for the vehicle extent locations in the location 254 or the variable memory 206.

Block 506 then directs the microprocessor 202 to use the vehicle extent locations 410 and 412 to determine a geometric layout of the non-circular central island 402 corresponding to the vehicle extents. Referring back to FIG. 4, in one embodiment, the vehicle extents are further offset by respective clearance allowance offsets S₁ and S₂ to provide additional clearance between the vehicle 336 and the plurality of splitter islands 308-314 or the central island 402. The clearance allowance offsets S₁ and S₂ may be received from the user or standard design values may be used. Similarly, clearance allowance offsets may be included to provide additional clearance between the vehicle 336 traveling along the approach roadways 316-322 and the plurality of splitter islands 308-314. For example, clearance allowance offsets S₃ and S₄ may be included for the approach roadway 322. In the processor embodiment shown in FIG. 2, the offsets S₁, S₂, S₃, and S₄ are stored in the location 256 of variable memory 206.

In one embodiment, the geometric layout of the central island is generated by determining an intersection between the initial circular central island 302 and the vehicle extent location line 410. The central island 402 geometric layout may then be constructed by trimming the portion 404 to generate the non-circular shape. Alternatively, the portion 404 may be used to represent a truck apron that is mountable by the vehicle 336 but is configured to discourage other vehicles, such as the vehicle 335 shown in FIG. 3, from traveling along the truck apron portion.

In other embodiments, vehicle movements between the various approach roadways 316, 318, 320, and 322 may be used to generate further portions of the non-circular central island 402 in the same way as the movement of the vehicle 336 through the roundabout between the approach roadways 322 and 320 is used to generate the portion 404. In this embodiment, the central island may be generated without the need to first generate an initial central island shape.

Block 508 then directs the microprocessor 202 to generate output data representing the geometric layout of the central island 402 and to store the output data in the central island layout location 258 in the variable memory 206.

Functions performed by the microprocessor 202 for implementing the blocks 502-508 are described in greater detail below.

### Design Vehicle

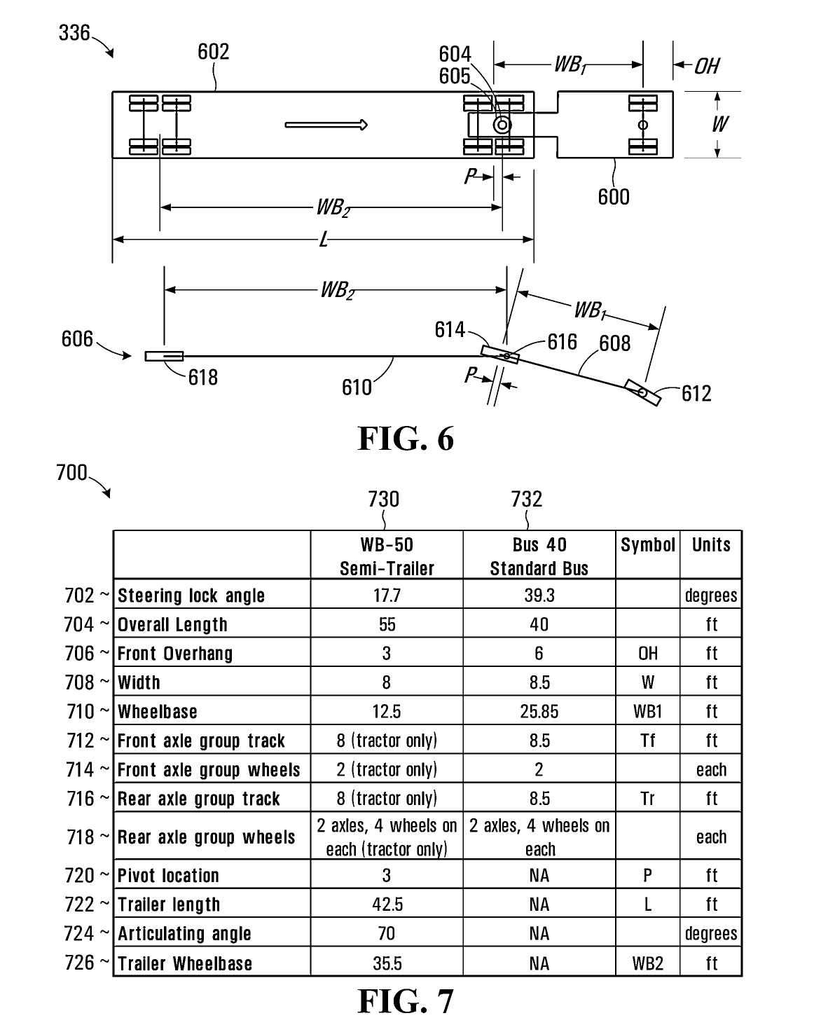

The semi-trailer vehicle 336 may be represented by a standard design vehicle provided by a policy for geometric design of traffic intersections. For example the design vehicle may be taken from the American Association of State Highway and Transportation Officials (AASHTO) library of standard design vehicles (A Policy on Geometric Design of Highways and Streets, 2004). Referring to FIG. 6, in one embodiment the vehicle 336 is represented by a WB-50 semi-trailer design vehicle, which is defined by a plurality of design vehicle parameters stored in a design vehicle database 260 in the variable memory 206 (shown in FIG. 2). The semi-trailer vehicle 336 includes a tractor 600 having a pivot location 604, and also includes a trailer 602 having a coupling 605 connected to the pivot location 604 of the tractor.

Referring to FIG. 7, a table listing examples of some parameters for standard design vehicles is shown generally at 700. The parameter listing 700 includes a first column of parameters 730 for a 50 ft Semi-trailer (WB-50) and a second column of parameters 732 for a 40 ft standard bus (Bus 40). The standard bus parameters are included in the table 700 for convenience and are referenced later herein. The parameter listing 700 includes a steering lock angle parameter 702 representing an angle through which the steering of the tractor 600 is capable of turning from a straight ahead condition. The parameter listing 700 also includes dimensions for overall vehicle length 704, front overhang 706 and body width 708, and wheelbase 710. For the tractor 600, the front overhang dimension 706 is taken from the center of the front wheel to the front extent of the vehicle and the wheelbase dimension 710 is taken between the center of the front wheel and the center of a rear axle group, which includes two spaced apart axles each having 4 wheels.

The parameter listing 700 also includes parameters associated with a front axle group, including the number of wheels per axle 714 and a track dimension 712. In this embodiment, the track dimension 712 is the distance between outer edges of the tire measured across the axle. Conventionally, track dimensions may refer to a distance between respective centers of an outer wheel tire, but for the purposes of intersection design the outside of the tire is more relevant for defining intersection features. Accordingly, when populating the design vehicle database 260 in the variable memory 206, conventional track dimensions are adjusted to correspond to the distance between the outer edges of the tire tread measured across the axle. In other embodiments, features other then the wheels may act as reference points for generating vehicle extents, and parameters defining the location of such features with respect to the wheels of the vehicle may be stored as additional fields in the parameter listing 700.

The parameter listing 700 also includes parameters associated with a rear axle group, including the number of wheels per axle 718 and a track dimension 716. The parameter listing 700 also includes a pivot location dimension 720, which is expressed as an offset from the center of the rear axle group of the tractor 600.

The parameter listing 700 also includes parameters for the trailer 602, such as a trailer length parameter 722 and an articulating angle parameter 724. The articulating angle parameter 724 represents is a maximum angle that may exist between a longitudinal centerline of the tractor 600 and a longitudinal centerline of the trailer 602 when turning the vehicle 336. The trailer 602 includes a coupling which is coupled to the pivot location 604. The parameter listing 700 also includes a trailer wheelbase parameter 726, which is a distance between the coupling at the pivot location 604 and a center of the trailer rear axle group.

In one embodiment, the design vehicle database 260 (shown in FIG. 2) may store sets of parameters 700 for a plurality of design vehicles, such as the semi-trailer vehicle 336, which facilitates selection of such vehicles for producing the representation of the traffic roundabout. For example, libraries of various standard design vehicles are implemented in the AutoTURN® software product available from Transoft Solutions Inc. of British Columbia, Canada. The libraries include commonly used design vehicles for different countries and also provide for custom definition of vehicles not available in the standard libraries.

### Bicycle Model

In order to reduce computational complexity, in one embodiment the semi-trailer vehicle 336 may be represented by a bicycle model shown generally at 606 in FIG. 6. The bicycle model 606 includes a bicycle model portion 608 for the tractor 600 and a bicycle model portion 610 for the trailer 602. The tractor portion 608 includes front and rear wheels 612 and 614 separated by a distance corresponding to the wheelbase dimension WB₁ of the tractor 600 and includes a pivot location 616 corresponding to the pivot location 604 for the tractor 600. The trailer portion 610 includes a fixed rear wheel 618, which is spaced from the pivot location 616 by a distance WB₂ corresponding to the wheelbase dimension of the trailer 600. In other design vehicle embodiments the rear wheel 618 may also be steerable to facilitate improved steerability of the vehicle.

In the embodiment shown, the front wheels of the semi-trailer vehicle 336 are steerable and the corresponding front wheel 612 of the bicycle model portion 608 is also steerable while the rear wheel 614 of the bicycle model portion 608 is fixed. In other embodiments the semi-trailer vehicle 336 may have steerable rear wheels, in place of or in addition to steerable front wheels, and the bicycle model 606 may thus include a corresponding steerable rear wheel 614 or steerable front and rear wheels.

For any arbitrary location of the bicycle model 606, the design vehicle parameters stored in the design vehicle database 260 may be used to determine corresponding locations of the wheels of the semi-trailer vehicle 336. For example, the front left hand wheel of the tractor 600 is spaced apart from the front wheel 612 of the bicycle model portion 608 by half of the track dimension 712 in a direction perpendicular to the wheelbase of the tractor 600. Locations of other vehicle extents, such as the right hand rear wheel for example, may be similarly computed using the design vehicle parameters in the design vehicle database 260.

The bicycle model 606 provides a simplified vehicle representation that may be used to reduce calculation overhead associated with representing the vehicle 336 using a more complex model. Alternatively, in embodiments where the calculation overhead is not regarded as an important performance criterion, the representation may proceed on the basis of a more complex representation that the bicycle model 606 shown in FIG. 6.

### Vehicle Path

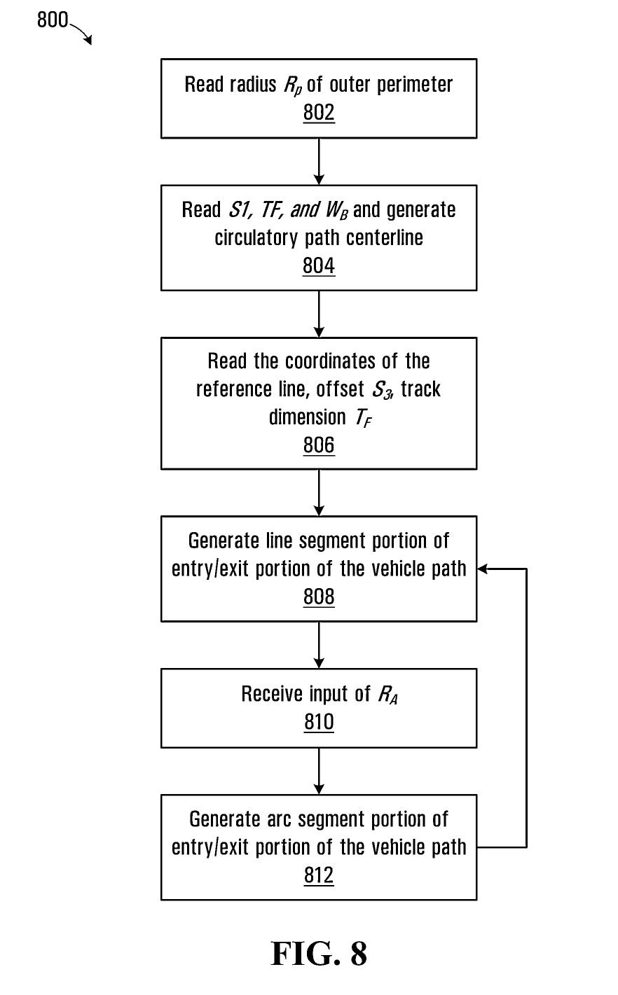

Referring to FIG. 8, a flowchart depicting blocks of code for directing the processor circuit 200 to implement block 502 of the process 500 shown in FIG. 5 for generating the vehicle path 406 is shown at 800. The vehicle path 406 (shown in FIG. 4) includes an entry portion 414, a circulating portion 416, and an exit portion 418.

The process 800 begins at block 802, which directs the microprocessor 202 to read the design radius R_{P} from the location 250. Block 804 then directs the microprocessor 202 to read the offset value S₁ from the location 256, and to read the track width T_{F} of the front wheels of the design vehicle from the design vehicle database 260. Block 804 then directs the microprocessor 202 to generate a circulatory path centerline 420 spaced inwardly from the outer perimeter 306. The radius of the circulatory path centerline 420 may be computed in accordance with the formula:

$${R}_{c} = \sqrt{{[ \sqrt{{( {R}_{p} - {S}_{1} )}^{2} - {W}_{B}^{2}} - \frac{{T}_{f}}{2} ]}^{2} + {WB}^{2}} \qquad Eqn 1$$

where:
R_{C} is the radius of the circulatory path centerline 420;
Rₚ is the radius of the outer perimeter 306;
S₁ is the first offset distance;
T_{F} is the track width of a front axle group of the vehicle 336; and
W_{B} is the wheelbase dimension of the vehicle 336.

The process 800 then continues at block 806, which directs the microprocessor 202 to read the coordinates of the reference line 428 for the approach roadway 322 and to read the offset S₃ from the store 256 and to read the track dimension T_{F} of the front axle of the semi-trailer vehicle 336 from the design vehicle database 260.

Block 808 then directs the microprocessor 202 to initiate generation of the entry and exit portions 414 and 418 of the vehicle path 406, in this embodiment starting with the entry portion 414. The entry portion 414 includes a line segment 430 spaced outwardly from the reference line 428 by a distance given by the formula:

S_{A}=S₃+½T_{F}+½Wᵢ Eqn 2

where:
S_{A} is the offset of the line segment 430 from the reference line 428;
S₃ is the clearance allowance offset;
T_{F} is the track width of a front axle group of the semi-trailer vehicle 336; and
Wᵢ is the width of the splitter island 314.

In Eqn 2 above it is assumed that the splitter island 314 is centered with respect to the corresponding reference line 428, however in other embodiments the splitter island may otherwise aligned and Eqn 2 would need to be revised accordingly.

The process then continues at block 810, which directs the microprocessor 202 to receive operator input of an approach radius R_{A}. The approach radius R_{A} is shown at 432 in FIG. 4 and defines an arc segment 434 of the entry portion 414 of the vehicle path 406. In this embodiment the arc segment 434 is defined by a simple radius R_{A}, however in other embodiments compound radii may be used to define the arc segment. The arc segment 434 extends from the line segment 430 and joins the circulatory path centerline 420 at a tangent point 436. The line segment 430 and arc segment 434 together make up the entry portion 414 of the vehicle path 406. In one embodiment the arc segment 434 may be constructed by constructing a circle of radius R_{A} and then positioning the circle successive points along the line segment 430 until the circle just intersects the circulatory path centerline 420 resulting in the circle being tangent to the circulatory path centerline at the tangent point 436. The 434 is then defined as a portion of the circle extending between a tangency point with the line segment 430 and the tangent point 436.

Blocks 808-812 may then be repeated for generating the exit portion 418 of the vehicle path 406 in a similar manner to the generation of the entry portion 414. As in the case of the entry portion 414, the exit portion 418 includes a line segment 438 and an arc segment 440, which touches the circulatory path centerline 420 at a tangent point 442 on the circulatory path centerline.

The vehicle path 406 thus includes the entry portion 414, the circulating portion 416 extending along the circulatory path centerline 420 between the tangent point 436 and the tangent point 442, and the exit portion 418 and provides a path for the semi-trailer vehicle 336 to follow (in this case for the center of the front axle) through the intersection.

### Vehicle Extents

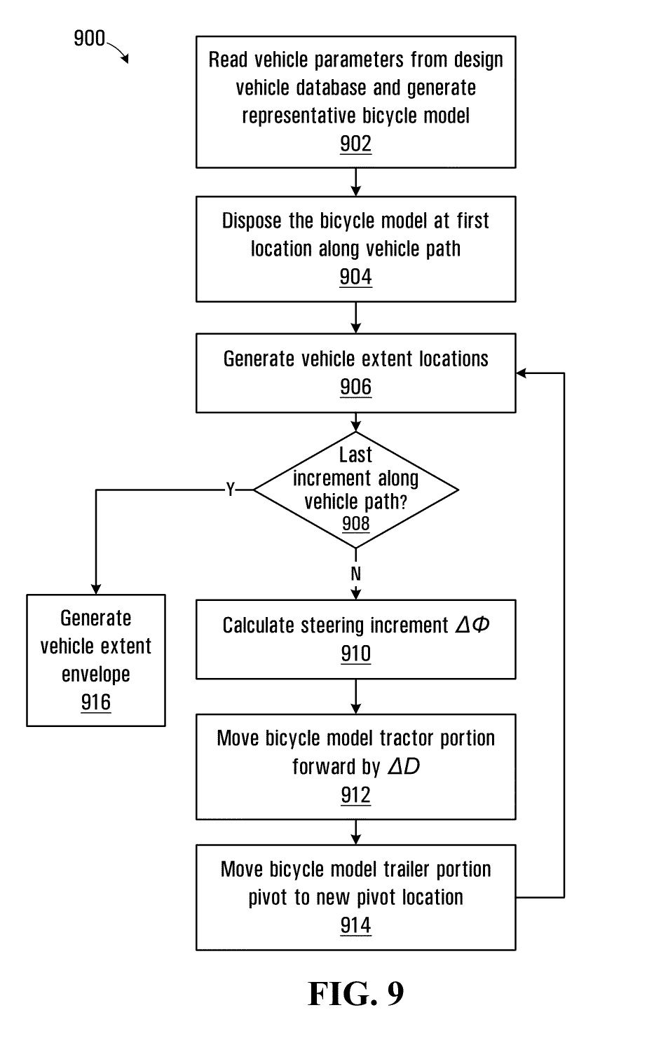

Referring to FIG. 9, a flowchart depicting blocks of code for directing the processor circuit 200 to implement block 504 of the process 500 shown in FIG. 5 for generating vehicle extent locations 410 and 412 is shown at 900. The process begins at block 902, which directs the microprocessor 202 to read the vehicle parameters including the wheel base dimensions WB₁ and WB₂ and the pivot location P and to generate the bicycle model 606 (shown in FIG. 6) corresponding to the semi-trailer vehicle 336.

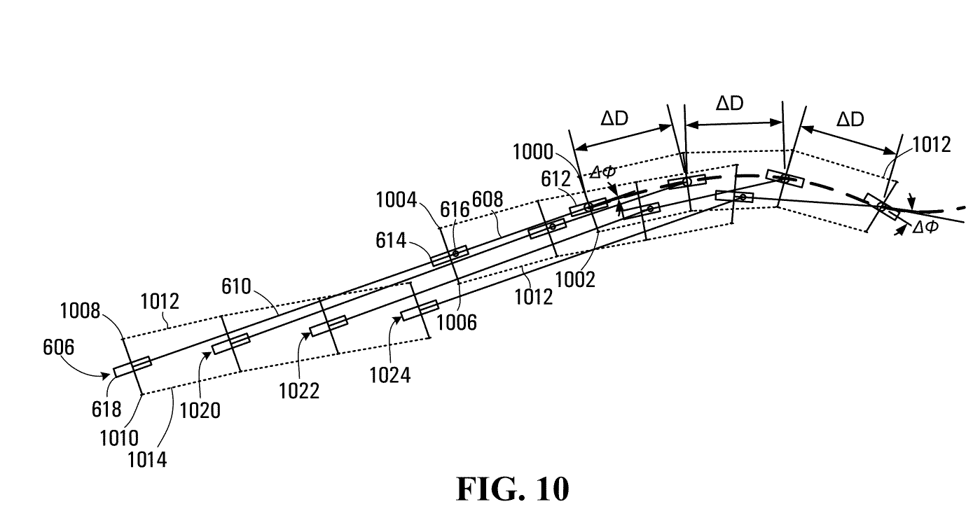

Block 904 then directs the microprocessor 202 to dispose the bicycle model 606 at a first location along the vehicle path 406. A portion of the vehicle path 406 is shown in FIG. 10. Referring to FIG. 10 the bicycle model 606 is disposed at a first location in which the tractor portion 608 and trailer portion 610 are oriented generally inline. In other embodiments where the approach roadway 322 is curved, the vehicle may be disposed at the first location in an initial orientation where the tractor portion 608 and trailer portion 610 are not oriented inline but are rather oriented at an angle to each other. The initial orientation may be provided by operator input, for example.

The process 900 then continues at block 906, which directs the microprocessor 202 to generate vehicle extents. As disclosed above vehicle extents are generated for portions or the vehicle 336 that would need to clear a curb associated with the central island 402 or any of the splitter islands 308-312, or any other obstacle located at sufficient height to impede passage of the vehicle. Accordingly, the vehicle extents in this case include vehicle extents 1000 and 1002 for the front wheel 612 of the tractor portion 608, vehicle extents 1004 and 1006 for the rear wheel 614 of the tractor portion, and vehicle extents 1008 and 1010 for the fixed rear wheel 618 of the trailer portion 610. Block 906 further directs the microprocessor 202 to store coordinates for the vehicle extent locations in the location 254 of the variable memory 206.

In the embodiment shown in FIG. 10, the vehicle extents are assumed to correspond to the various wheel locations. However as disclosed above, in other embodiments features other then the wheels may be important in determining whether a vehicle has sufficient clearance for passage through the roundabout. Such features may include portions of the vehicle body or portions of a load carried by the vehicle. In such cases, the parameter listing 700 shown in FIG. 7 may include parameters defining an offset between the vehicle wheels and reference points that define such features, and generating the vehicle extents may involve determining locations of these reference points with respect to the wheel locations of the vehicle 336.

Block 908 then directs the microprocessor 202 to determine whether further vehicle extent locations remain to be generated, in which case block 908 directs the microprocessor 202 to block 910. The process then continues at block 910, which directs the microprocessor 202 to calculate a steering angle increment Δφ for the steerable front wheel 612. In this embodiment the steering increment Δφ corresponds to an angle between a current steering angle of the front wheel 612 of the bicycle model 606 and a line drawn tangent to the vehicle path 406. For the bicycle model 606 in the first location along the vehicle path 406, the steering increment Δφ is very small as indicated in FIG. 10. Block 910 also directs the microprocessor to change an orientation of the wheel 612 by the steering increment Δφ, which defines a new movement direction for the front wheel that is tangent to the vehicle path 406 at the location of the front wheel.

The process then continues at block 912, which directs the microprocessor 202 to move the bicycle model of the tractor portion 608 forward by an increment ΔD along the vehicle path 406 in the direction of the front wheel 612 to a second location 1020. In one embodiment, the increment ΔD is about 4 inches (about 100 mm) and the new location 1020 results in corresponding new locations for the front wheel 612, rear wheel 614, and pivot location 616 as shown in FIG. 10.

Block 914 then directs the microprocessor 202 to move the trailer portion 610 to the new location 1020. This involves moving the trailer portion 610 of the bicycle model 606 such that the coupling is re-located to the pivot location 616 on the tractor portion 608. The tractor portion 608 thus follows the vehicle path 406 while the trailer portion 610 follows a path of the pivot location 616. Block 914 then directs the microprocessor 202 back to block 906, which directs the microprocessor 202 to generate vehicle extent locations for the incremented location of the bicycle model 606 along the vehicle path 406.

Blocks 908-914 are repeated for successive new locations 1022 and 1024 until at block 908, no further vehicle extent locations remain to be generated, and the microprocessor is directed to block 916.

Block 916 then directs the microprocessor 202 to generate a vehicle extent envelope from the various coordinates of vehicle extents stored in the location 254 of the variable memory 206. During movement of the bicycle model 606 along the vehicle path 406, some of the generated vehicle extents will be located inside of other vehicle extents.

For example, extents 1010 generated by the fixed rear wheel 618 of the trailer portion 610 are disposed outside of the extents 1006 generated by the rear wheel 614 of the trailer portion and thus the extents 1010 will provide an overall extent of the vehicle 336 on a first side of the vehicle path 406. Similarly, extents 1000 generated by the front wheel 612 of the tractor portion 608 are disposed outside of the extents 1004 generated by the rear wheel of the tractor portion and the extents 1008 generated by the rear wheel 614 of the trailer portion. Accordingly, in the case shown in FIG. 10, the extents 1000 and 1010 will provide an overall extent of the vehicle 336 for the specific portion of the vehicle path 406 that is shown in FIG. 10. As the vehicle 336 is steered further along the vehicle path 406 the extents 1000-1010 that are active in defining the overall vehicle extents may change. For example, referring back to FIG. 4, when the semi-trailer vehicle 336 shown in FIG. 10 is leaving the roundabout 400 along the exit lane 340 of the roadway 320, the vehicle extents 412 are provide by the rear wheels of the tractor 600 rather than by either the front wheels of the tractor or the rear wheels of the trailer.

The CAD system 102 thus includes functions that determine which of the vehicle extents is active in defining an outside envelope of vehicle extents corresponding to movement of the vehicle 336 along the vehicle path 406. Block 916 thus directs the microprocessor 202 to process the vehicle extent coordinates to generate overall vehicle extents 410 and 412 (shown in FIG. 4) for the vehicle 336 traveling long the vehicle path 406 by combining the tire tracks (i.e. front and rear tire tracks) and determining an outermost boundary. In one embodiment, block 916 directs the microprocessor 202 to determine which tire track initially provides an outer extent at the beginning of the vehicle path 406 and then to add intersection points whenever one track (front or rear) intersects with another track (front or rear) as the vehicle is moved along the vehicle path through the roundabout. The outside envelope of the vehicle extents is then generated by directing the microprocessor 202 to initially determine the envelope boundary using the tire track providing the initial outer extent and to select a different track for determining the boundary at each intersection point.

### Central Island Layout

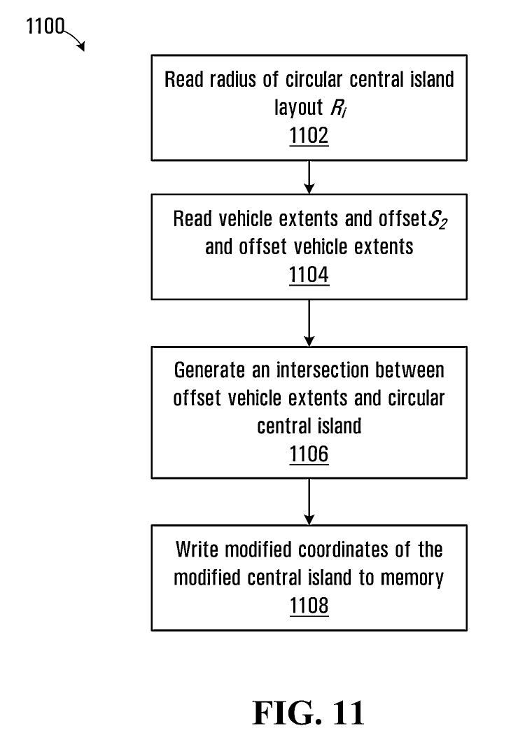

Referring to FIG. 11, a flowchart depicting blocks of code for directing the processor circuit 200 to implement block 506 of the process 500 shown in FIG. 5 for generating a geometric layout of the central island is shown at 1100. The process begins at block 1102, which directs the microprocessor 202 to read the radius of the circular central island 302 (shown in FIG. 3) from the location 250 of the variable memory 206. Block 1104 then directs the microprocessor 202 read the processed vehicle extents 410 and to read the clearance allowance offset S₁ from the location 256 of variable memory 206. Block 1104 also directs the microprocessor 202 to offset the vehicle extents 410 by the clearance allowance S₁ to provide additional clearance for the vehicle 336 traveling around the central island 402 (shown in FIG. 4).

The process then continues at block 1106, which directs the microprocessor 202 to generate an intersection between the offset vehicle extents and the circular central island 302 to provide the modified non-circular central island 402 shown in FIG. 4.

Block 1108 then directs the microprocessor 202 to store data and coordinates defining the non-circular central island 402 into the location 258 of the variable memory 206. In embodiments where the portion 404 is to be configured as a truck apron, block 1108 also directs the microprocessor 202 to store data and coordinates separately defining the portion 404 in the location 258 of the variable memory 206. The stored data defining the non-circular central island 402 and/or portion 404 provides output data for displaying the resulting roundabout 400 as shown in FIG. 4 on the display 114, or for generating hardcopy on the plotter 116.

### Lane Change Embodiment

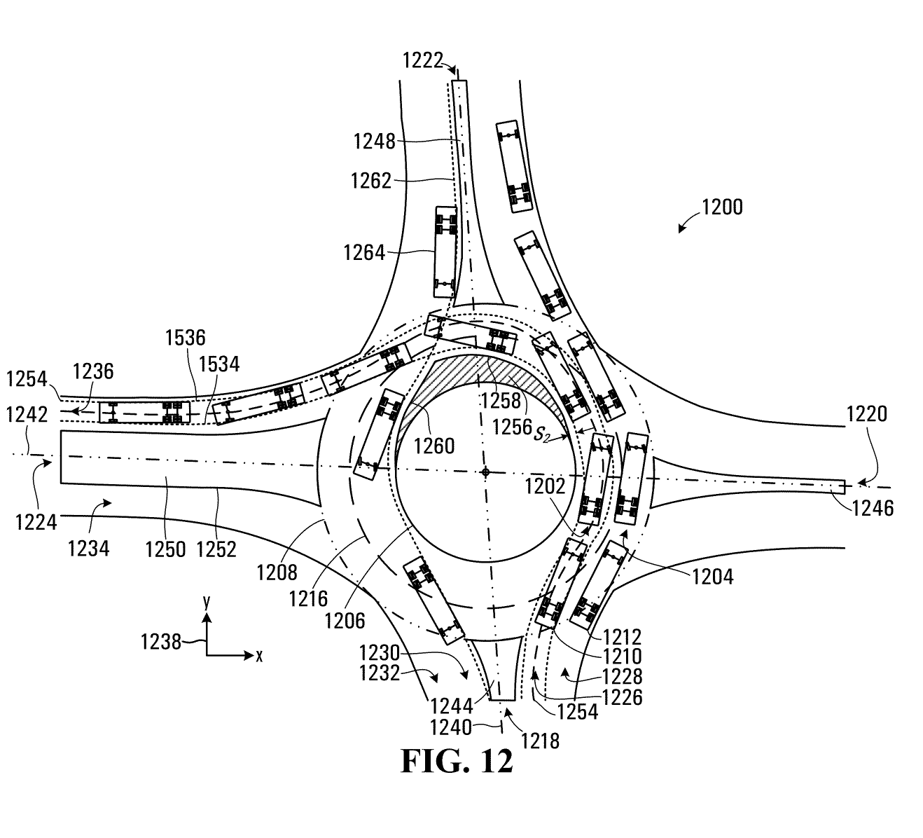

In another embodiment of the invention the roundabout may include more than one circulating lane and the process 500 shown in FIG. 5 may be implemented to generate a geometric layout of a central island that causes vehicles to undergo a lane change before exiting the roundabout. Referring to FIG. 12, a layout of a roundabout in accordance this embodiment is shown generally at 1200. The layout 1200 includes two adjacent circulatory lanes, including an inner circulatory lane 1202 and an outer circulatory lane 1204, each extending through the roundabout a central island 1206. In this embodiment the central island 1206 is initially shown as being circular but in other embodiments the initial shape of the central island may be oval or otherwise shaped. In other embodiments the roundabout may also include more than two adjacent circulatory lanes.

As described above in connection with FIG. 3, an initial layout of the roundabout layout 1200 may have been previously generated by the apparatus 100 shown in FIG. 1. Accordingly, a radius of the circular central island 1206 and an outer perimeter 1208 would already been established to accommodate passage of a vehicle 1210 through the roundabout on the circulatory lane 1202 and passage of a vehicle 1212 through the roundabout on the circulatory lane 1204. Similarly, an initial extent of the circulatory lanes 1202 and 1204 may also have already been initially determined as indicated by the lane divider 1216. Data defining an initial layout of the roundabout is stored in the location 250 of the variable memory 206 shown in FIG. 2, and in this embodiment would additionally include data defining an extent of each of the circulatory lanes 1202 and 1204.

The layout 1200 further includes a plurality of approach roadways 1218, 1220, 1222, and 1224. In this embodiment, roadways 1218, 1220, and 1222 each include a pair of entry lanes and a pair of exit lanes, while roadway 1224 includes a single entry lane and single exit lane. For example, the approach roadway 1218 includes an inner entry lane 1226, an outer entry lane 1228, an inner lane 1230, and an outer exit lane 1232. Alternatively, the intersection may be otherwise configured to include a greater or a fewer number of approach roadways, entry lanes, and exit lanes as required.

Elements making up the layout 1200 of the roundabout shown in FIG. 12 are defined by coordinates in an x-y Cartesian coordinate system 1238. An orientation of each of the plurality of approach roadways 1218, 1220, 1222, and 1224 in the x-y Cartesian coordinate system 1238 is defined by reference lines 1240 and 1242. In this embodiment, since the approaches 1218 and 1222 are aligned along a common line and the approaches 1224 and 1220 are aligned along a common line, only two reference lines 1240 and 1242 are required to fully define the orientation of the approach roadways with respect to the central island 1206. In other embodiments the approach roadways may not be aligned along common lines, as was the case in the FIG. 3 embodiment disclosed above.

The outer perimeter 1208 is used to define portions of a plurality of splitter islands 1244, 1246, 1248, and 1250 that bound the outer circulatory lane 1204 and divide the respective approach roadways 1218, 1220, 1222, and 1224 into entry and exit lanes. In this embodiment, the splitter island 1250 is wider than other splitter islands 1244, 1246 and 1248, and is configured to narrow the approach roadway 1224 to only a single entry lane 1234 and a single exit lane 1236. In other embodiments, the splitter island 1250 may initially be configured to include a pair of entry lanes and a pair of exit lanes, and may be widened to constrain the approach roadway 1224 to a single exit and/or entry lane following implementation of the methods described below.

In this embodiment, the central island 1206 of the roundabout layout 1200 is initially configured as a circular central island, which would permit traffic flow one each of the two adjacent circulatory lanes 1202 and 1204 about the central island. Accordingly, the vehicle 1210 entering the roundabout on the inner entry lane 1226 would be able to travel about the initially circular island 1206 on the inner circulatory lane 1202 and exit the approach roadway 1224 on an inside exit lane adjacent to the splitter island 1250. However, implementation of the process of this embodiment involves generating a vehicle path 1254 for travel of the vehicle 1210 through the roundabout while making a lane change from the inner circulatory lane 1202 to the outer circulatory lane 1204. In the embodiment shown in FIG. 12 the vehicle 1210 follows a generally spiral path which has a linearly increasing radius while making the lane change. In other embodiments the spiral lane change path may have a non-linearly increasing radius or the lane change may not be based on a spiral path but some other path as described later herein with reference to FIG. 18. While the lane change in this embodiment is described as being a lane change from the inner circulatory lane 1202 to the outer circulatory lane 1204, in other embodiments the lane change may be from the outer circulatory lane to an inner circulatory lane, although such a lane change would be less common in roundabout design.

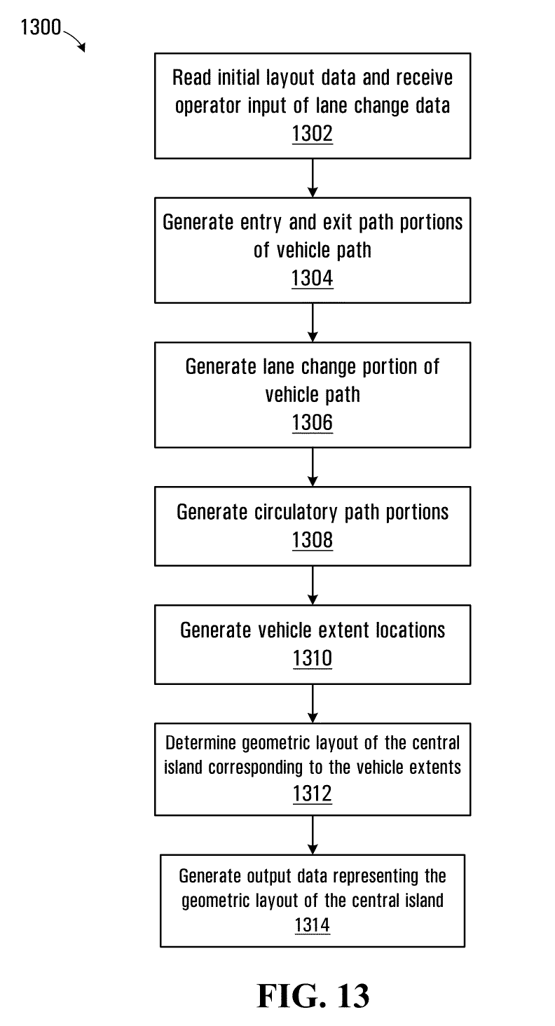

A flowchart depicting blocks of code for directing the processor circuit 200 to implement block 502 of the process 500 (shown in FIG. 5) for generating the vehicle path 1254 including a lane change is shown at 1300 FIG. 13. Referring to FIG. 13, the process begins at block 1302, which directs the microprocessor 202 shown in FIG. 2 to read initial roundabout layout data from the location 250 of the variable memory 206 (FIG. 2), which as in the above FIG. 4 embodiment may have been previously generated by the apparatus 100, determined by manual calculation, or determined by other methods. Block 1302 also directs the microprocessor 202 to receive operator input of data associated with the lane change.

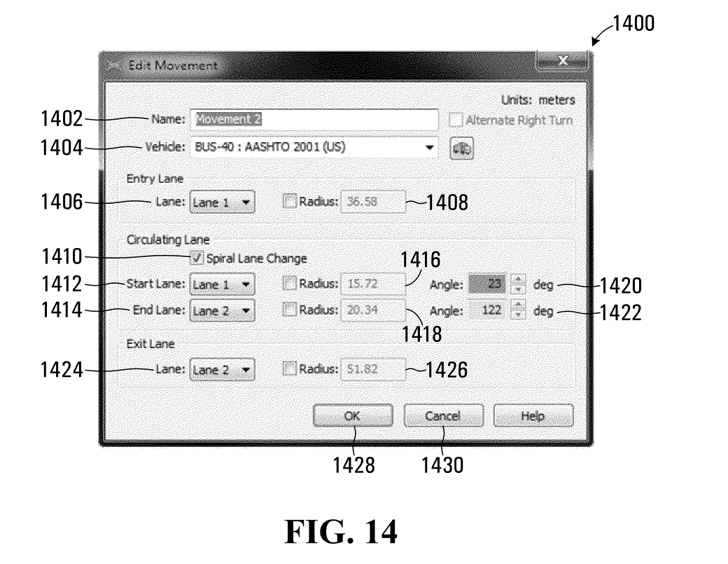

Referring to FIG. 14, in one embodiment operator input is received through an operator input window 1400, which is displayed on the display 114 shown in FIG. 2. The operator input window 1400 includes a plurality of data input fields, including a field 1402 for entering a name associated with the lane change movement, which in this case references a movement between the approach roadway 1218 and the approach roadway 1224.

The operator input window 1400 also includes a field 1404 for entering a selection of a vehicle for generating the vehicle path 1254 including the lane change. Referring back to FIG. 12, in this embodiment the vehicle 1210 is a Bus 40 standard bus, which is defined by parameters listed in column 732 of the table 700 shown in FIG. 7.

The operator input interface window 1400 further includes a field 1406 for selecting one of the entry lanes 1226 and 1228 for entry of the vehicle 1210 into the roundabout, and a field 1408 for optionally entering an approach radius associated with the vehicle path traveling along the entry lane 1226. In this embodiment, the approach radius has already been provided in the initial layout data. However, the operator may optionally click the checkbox adjacent to the field 1408 and enter a radius that would override the previously provided approach radius.

The operator input window 1400 also includes a spiral lane change checkbox field 1410, which when checked indicates that the vehicle should perform a lane change while traveling along the circulatory lane 1202 of the roundabout. The operator input window 1400 further includes a start lane field 1412 for selecting which of the inner or outer circulatory lanes should be the starting lane for the lane change. In this embodiment “lane 1” is selected corresponding to the inner circulatory lane 1202. The operator input window 1400 also includes an end lane field 1414 for selecting which of the inner or outer circulatory lanes should be the end lane for the lane change. In this embodiment “lane 2” is selected corresponding to the outer circulatory lane 1204. As in the case of the approach radius of the vehicle path along the entry lane 1226, the start lane field 1412 and end lane field 1414 have associated fields 1416 and 1418 for accepting optional input of a circulatory lane radius, should the operator whish to override previously read radii from the initial layout data location 250 of the variable memory 206.

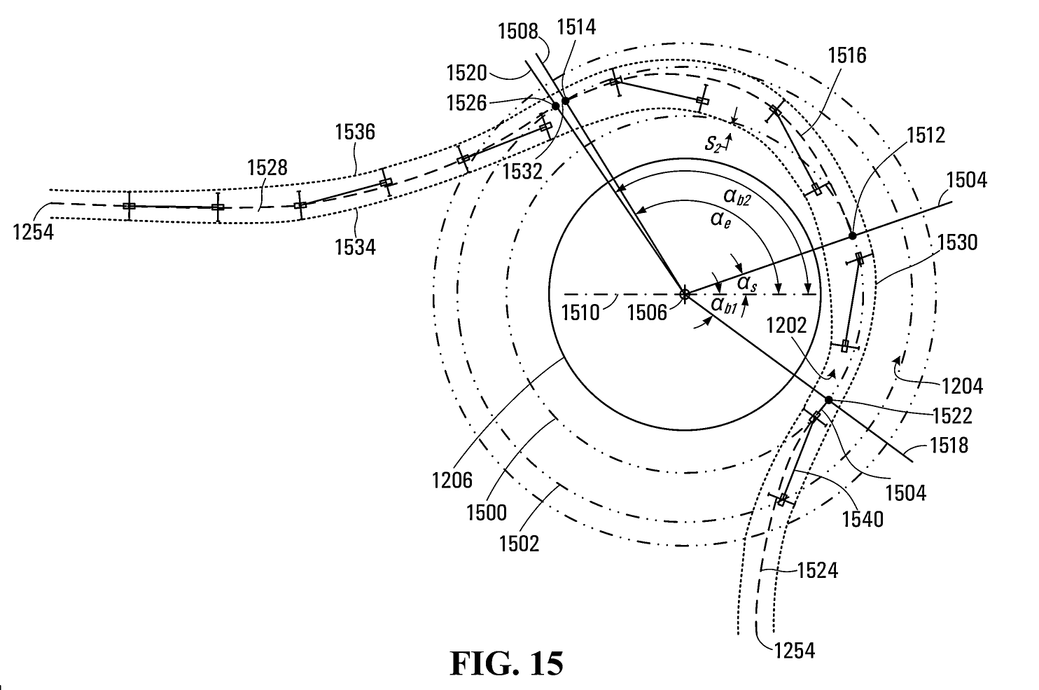

The operator input window 1400 also includes an angle field 1420 associated with the start lane field 1412 and an angle field 1422 associated with the end lane field 1414. The vehicle path 1254 is shown in enlarged detail in FIG. 15. Referring to FIG. 15, the vehicle 1210 is represented by a bicycle model 1540 as described above in connection with the semi-trailer vehicle 336 and corresponding bicycle model 606. An inner circulatory path centerline 1500 is associated with the inner circulatory lane 1202 and an outer circulatory path centerline 1502 is associated with the outer circulatory lane 1204. A start angle line 1504 is shown extending outwardly from an origin point 1506 on the central island and indicates the start angle αₛ. Similarly, an end angle line 1508 is shown extending outwardly from the origin point 1506 and indicates the end angle αₑ. The angles αₛ and αₑ are referenced to a notional horizontal line 1510. In the embodiment shown the origin point 1506 is at the center of the central island 1206, although other origin points or reference lines on the central island may be selected for referencing the start and end angles associated with the spiral lane change. The line 1504 at angle αₛ defines a start point 1512 for the lane change where the line 1504 intersects with the inner circulatory path centerline 1500 and the line 1508 at angle αₑ defines an end point 1514 for the lane change where the line intersects with the outer circulatory path centerline 1502. A lane change path portion 1516 extends between the start point 1512 and end point 1514.

In one embodiment, block 1302 may direct the microprocessor 202 to constrain the start point 1512 and the end point 1514 to fall between a first boundary angle α_{b1} and a second boundary angle α_{b2}, shown defined by respective lines 1518 and 1520 in FIG. 15. In this embodiment the first boundary angle α_{b1} corresponds to a location of a point 1522 on the inner circulatory path centerline 1500 at which an entry path portion 1524 associated with a vehicle entering the roundabout along the inner entry lane 1226 intersects with the inner circulatory path centerline 1500. Similarly, the second boundary angle α_{b2} corresponds to a location of a point 1526 on the outer circulatory path centerline 1502 at which an exit path portion 1528 associated with the vehicle 1210 exiting the roundabout along the exit lane 1236 leaves the outer circulatory path centerline 1502.

Referring back to FIG. 12, in one embodiment block 1302 may direct the microprocessor 202 to constrain a location of the start point such that the vehicle traveling along the lane change path would not interfere with the vehicle 1212 traveling along the lane outer circulatory lane 1204 and exiting the roundabout at another exit lane, such as an exit lane of the approach roadway 1222. By constraining the start point of the lane change the vehicle 1210 is prevented from entering the outer circulatory lane 1204 before the vehicle 1212 begins to leave the outer circulatory lane. In general, this involves generating vehicle extents for the vehicle 1210 and the vehicle 1212 and determining a value for α_{b1} that removes overlap between the respective vehicle extents.

Referring again to FIG. 14, the operator input window 1400 also includes a field 1424 for selecting an exit lane for exit of the vehicle 1210 from the roundabout, and a field 1426 for optionally entering an approach radius associated with the vehicle path traveling along the exit lane 1236. As disclosed above, in this embodiment the approach radius has already been provided in the initial layout data stored in the location 250 of the variable memory 206, however the operator may click the checkbox adjacent to the field 1426 and enter a radius that would override the previously provided approach radius.

The operator input window 1400 also includes control buttons “OK” 1428 and “Cancel” 1430 and when data defining the spiral lane change has been entered in the operator input window 1400, clicking on the “OK” control button 1428 causes the data fields to be written to the lane change data location 262 of the variable memory 206.

Referring back to FIG. 13, the process 1300 then continues at block 1304, which directs the microprocessor 202 to generate the entry path portion 1524 and the exit path portion 1528 of the vehicle path 1254. Generation of the entry and exit path portions 1524 and 1528 generally follow the same process steps as disclosed above in FIG. 8 at blocks 808-812 and result in generation of an entry path portion 1524 that joins the inner circulatory path centerline 1500 and is tangent to the centerline at the point 1522 and an exit path portion 1528 that joins the outer circulatory path centerline 1502 and is tangent to the centerline at the point 1526.

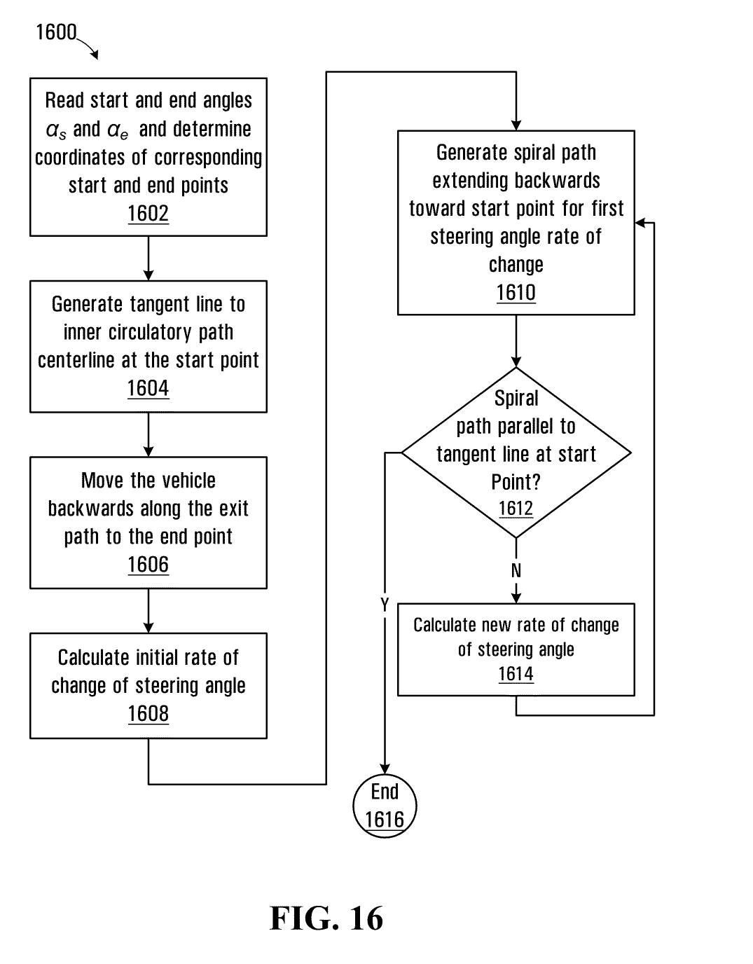

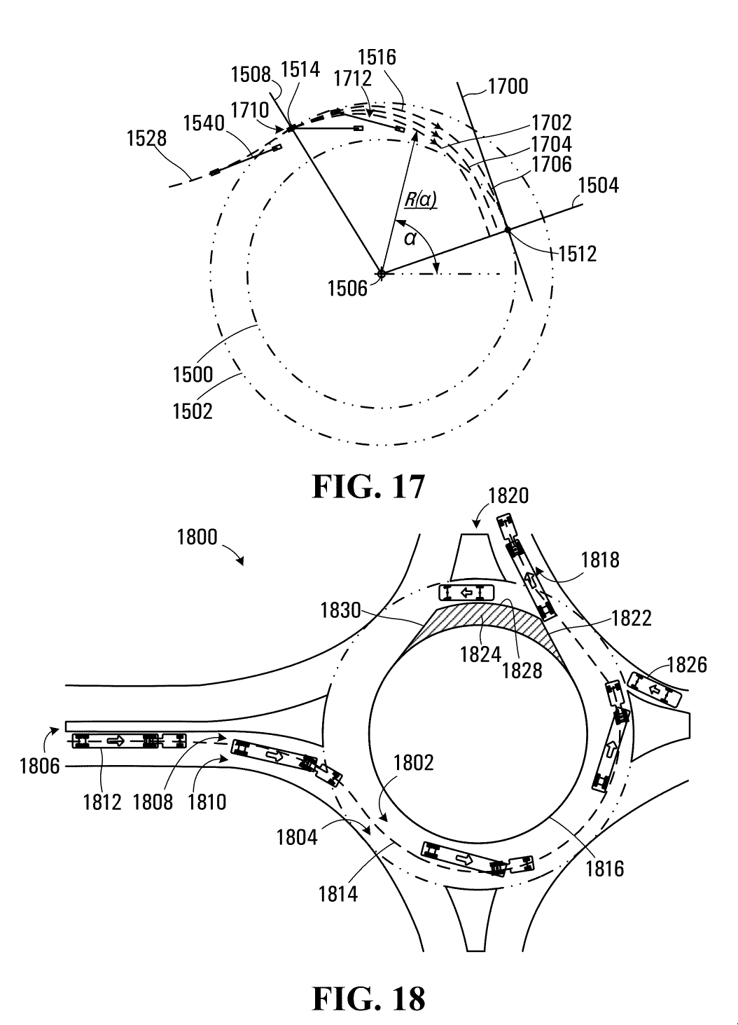

The process then continues at block 1306, which directs the microprocessor 202 to generate the lane change path portion 1516. Referring to FIG. 16, a process for implementing block 1306 of the process 1300 is shown generally at 1600. The process begins at block 1602 which directs the microprocessor 202 to read the start and end angles αₛ and αₑ and determine corresponding coordinates of the start and end points 1512 and 1514. Block 1604 then directs the microprocessor 202 to construct a tangent line to the inner circulatory path centerline 1500 at the start point 1512. The inner and outer circulatory path centerlines 1500 and 1502 are shown in FIG. 17. Referring to FIG. 17, the tangent line is shown at 1700 and may be constructed by invoking a tangent CAD function provided by the CAD system 102 shown in FIG. 1.

The lane change path portion 1516 may be constructed to be tangential to the inner circulatory path centerline 1500 at the start point 1512. In one embodiment this may involve The process 1600 then continues at block 1606, which directs the microprocessor 202 to move the vehicle 1210 backwards from the end point 1514 toward the start angle line 1504. In FIG. 17 the backwards movement corresponds to movement of the bicycle model 1540 from a location 1710 to a location 1712 and to other successive locations.

Block 1608 then directs the microprocessor 202 to calculate an initial rate of change of steering angle for the vehicle 1210. Referring back to FIG. 7, the Bus 40 vehicle 1210 has a steering lock angle parameter 702 of 39.2°, which would correspond to the tightest path that can be steered by the vehicle. In practice for a vehicle moving through an intersection, the rate at which the steering angle of the vehicle can safely and practically be changed is limited by the traveling speed of the vehicle. This rate is commonly expressed as a lock-to-lock time, which is commonly expressed as a function of vehicle speed for common design vehicles such as the vehicle 1210. Accordingly, generating the first spiral at block 1608 may involve calculating a rate of change of steering angle on the basis of the lock-to-lock time at a speed v associated with the vehicle travelling along a radius corresponding to a radius of the outer circulatory path centerline 1502. The change in steering angle results in a spiral path having a radius R(α) that changes with a change in the angle α as the vehicle is steered backwards toward the start angle line 1504. In one embodiment, the design speed v may be selected based on operator selection of a desired speed of travel through the roundabout.

Block 1610 of the process 1600 then directs the microprocessor 202 to steer the vehicle 1210 along a spiral path extending backwards through the roundabout from the end point 1514 toward the start point 1512 while changing the steering angle of the vehicle at the rate calculated at block 1608. Referring to FIG. 17, the corresponding generated spiral path is shown at 1702 and represents a first spiral path that a bicycle model 1710 of the vehicle 1210 could follow while moving backwards from the end point 1514.

Block 1612 then directs the microprocessor 202 to determine whether the first spiral path 1702 intersects and is parallel to the tangent line at a point of intersection with the start angle line 1504. For the first spiral path 1702 this criterion would not be met and block 1612 thus directs the microprocessor 202 to block 1614.

Block 1614 directs the microprocessor 202 to calculate a new rate of change of steering angle. For the case shown in FIG. 17, the new rate of change of steering angle of the bicycle model 1710 should be lower than the rate of change calculated at block 1608 to move the point of intersection toward the tangent line 1700. Block 1614 then directs the microprocessor 202 back to block 1610 and a new spiral path as shown at 1704 in FIG. 17 is generated. Blocks 1610, 1612, and 1614 are repeated until at block 1612, the generated spiral path is parallel to the tangent line at a point of intersection with the start angle line 1504, within some threshold tolerance. For example, in one embodiment the criterion is considered to be satisfied when a generated spiral path has two consecutive vehicle positions are within about 0.4 inch (10 mm) of the tangent line 1700 without crossing over the tangent line. If the generated spiral path crosses over the tangent line 1700 before the 1512, the spiral path will not be tangent at the start point 1512. In the case shown in FIG. 17 this criterion is met by the spiral path 1706 and the path 1706 is thus selected as the lane change path portion 1516 of the vehicle path 1254. The process 1600 would generally result in a short portion of the lane change path extending along the tangent line between the spiral lane change path portion 1516 and the start point 1512. In other embodiments this short tangent portion may be reduced or eliminated by generating a spiral that passes through the start point 1512, and in such an embodiment block 1604 may be omitted from the process 1600. Block 1612 then directs the microprocessor 202 to block 1616 where the process 1600 ends.

Referring back to FIG. 13, following generation of the lane change path portion 1516 at block 1306, the process 1300 continues at block 1308, which directs the microprocessor 202 to generate remaining portions of the vehicle path 1254. The remaining portions of the vehicle path include an inner circulatory path portion 1530 that extends along the inner circulatory path centerline 1500 between the entry path portion 1524 and the lane change path portion and an outer circulatory path portion 1532 that extends along the outer circulatory path centerline 1502 between the lane change path portion and the exit path portion 1528. Block 1308 directs the microprocessor 202 to generate the portion 1530 as an arc having a radius corresponding to the radius of the inner circulatory path centerline 1500 and extending between the first boundary angle α_{b1} and the start angle αₛ. Block 1308 also directs the microprocessor 202 to generate the portion 1532 as an arc having a radius corresponding to the radius of the outer circulatory path centerline 1502 and extending between the second boundary angle α_{b2} and the start angle αₛ. The vehicle path 1254 thus includes the entry path portion 1524, portion inner circulatory path portion 1530, lane change path portion 1516, outer circulatory path portion 1532, and exit path portion 1528.

Block 1310 then directs the microprocessor 202 to generate vehicle extent locations for the bicycle model 1710 and thus for the vehicle 1210. The process of block 1310 for generating the vehicle extents generally follows the process 900 shown in FIG. 9, except that block 914 of the process 900 is omitted, since the vehicle 1210 does not include a trailer portion. Referring back to FIG. 13, the vehicle extent locations are represented by broken lines 1534 and 1536 and as in the case shown in FIG. 4 an offset S₂ is provided as a clearance allowance between the vehicle 1210 and the central island 1206.

The process 1300 then continues at block 1312, which directs the microprocessor 202 to use the vehicle extent locations 1534 and 1536 to determine a geometric layout of the central island 1206 corresponding to the vehicle extents by extending the central island to the vehicle extent locations 1534, offset by the clearance allowance S₂. The implementation of block 1312 generally follows the process 1100 shown in FIG. 11, except that at block 1106 the central island 1206 is extended rather than reduced in size. Referring to FIG. 13, the central island 1206 is extended by an island extension portion 1256 to block or constrain traffic movements in at least a portion of the inner circulatory lane 1202 leading to the exit lane 1236. The island extension portion 1256 includes an extent 1258 generated from the vehicle extent locations 1534 provided by the vehicle 1210 undergoing the lane change. In this embodiment, the island extension portion 1256 also has an extent 1260 defined by generating further vehicle extents 1262 for a vehicle 1264 traveling through the inner circulatory lane 1202 from the approach roadway 1222 to the inner lane 1230 of the approach roadway 1218. In the embodiment shown the vehicle 1264 is also a standard bus-40 vehicle, but in other embodiments the vehicle 1264 may be selected as a passenger vehicle or other standard design vehicle, and as such the layout of the extension portion 1256 may be determined on the basis of a set of two or more design vehicles.

The island extension portion 1256 may be configured having a physical curb edge that acts as a barrier to vehicle movement. Alternatively, the island extension portion 1256 may be constructed using different materials from the remaining roadways making up the roundabout or may be indicated by marking the pavement of the roundabout using painted markings.

The process 1300 then continues at block 1314, which directs the microprocessor 202 to generate output data representing the geometric layout of the central island 1206 and to store the output data in the central island layout location 258 in the variable memory 206.

Referring to FIG. 18, an alternative lane change embodiment is shown generally at 1800. In this embodiment the roundabout includes an inner circulatory lane 1802 and an outer circulatory lane 1804 and an approach roadway 1806 includes an inner entry lane 1808 and an outer entry lane 1810. On entering the roundabout, a vehicle 1812 traveling along the inner entry lane 1808 makes a lane change from the inner entry lane 1808 to the outer circulatory lane 1804 along a vehicle path 1814. The vehicle 1812 travels about a central island 1816, and exits on an exit lane 1818 of an approach roadway 1820. Vehicle extents are then generated for the vehicle 1812 as described above in connection with the embodiment shown in FIG. 3 and FIG. 4, which provides a first extent 1822 of a central island extension 1824. Similarly, a second vehicle, such as the vehicle 1826 may be used to generate a further extent 1828 defining the central island extension 1824. Other extents 1830 of the central island extension 1824 may be similarly generated. The embodiment shown in FIG. 18 differs from the embodiment shown in FIG. 12, in that the lane change occurs earlier on entering the roundabout.

Embodiments of the invention disclosed above result in generation of complex central island shapes that are reduced in size, extended or otherwise modified from an initial central island shape to provide for or accommodate specific traffic movements through the roundabout. The resulting computer generated central island shape may facilitate smoother movement of vehicles through the roundabout and may also facilitate computer generation of complex roundabout layouts.

While specific embodiments of the invention have been described and illustrated, such embodiments should be considered illustrative of the invention only and not as limiting the invention as construed in accordance with the accompanying claims.

What is claimed is:

1. A method for computer generation of a geometric layout representing a central island of a traffic roundabout, the method comprising:
generating a vehicle path associated with travel of a vehicle through the roundabout;
generating vehicle extent locations associated with travel of said vehicle along said vehicle path;
using said vehicle extent locations to determine a geometric layout of the central island corresponding to said vehicle extents; and
generating output data representing said geometric layout of the central island.

2. The method of claim 1 wherein the roundabout includes at least two adjacent lanes extending through at least a portion of the roundabout and wherein generating the vehicle path comprises generating a vehicle path associated with travel of a vehicle through the roundabout while making a lane change from a first lane to a second lane of the at least two adjacent lanes.

3. The method of claim 2 wherein the roundabout comprises at least two adjacent circulatory lanes and at least two corresponding entry lanes associated with an approach to the roundabout, and wherein generating said vehicle path comprises generating a vehicle path associated with travel of the vehicle through the roundabout while making a lane change from a first entry lane to a second circulatory lane.

4. The method of claim 3 wherein the roundabout comprises at least two adjacent circulatory lanes and wherein generating said vehicle path comprises generating a vehicle path associated with travel of the vehicle through the roundabout while making a lane change from the first circulatory lane to the second circulatory lane.

5. The method of claim 3 wherein generating said vehicle path comprises:
generating a first path portion representing travel of the vehicle along said first lane;
generating a second path portion representing travel of the vehicle along said second lane; and
generating a lane change path extending between said first path portion and said second path portion.

6. The method of claim 5 wherein generating said lane change path comprises generating a spiral path extending between said first path portion and said second path portion.

7. The method of claim 6 wherein generating said spiral path comprises generating a spiral path between a start point on the first path portion and an end point on the second path portion.

8. The method of claim 7 further comprising receiving operator input of said start point and said end point.

9. The method of claim 7 wherein the start point and end point are each defined by an intersection of a line with the respective first and second path portions, the line extending outwardly from an origin point on the central island.

10. The method of claim 9 wherein the origin point on the central island comprises a center point of the central island.

11. The method of claim 7 further comprising constraining said start point and said end point to fall between a first boundary angle and a second boundary angle, each of the first and second boundary angles being defined by a line extending outwardly from an origin point on the central island.

12. The method of claim 11 wherein the origin point on the central island comprises a center point of the central island.

13. The method of claim 11 wherein:
generating said first path portion comprises generating a first circulatory path associated with travel of the vehicle along the first lane, the first path portion comprising a portion of said first circulatory path;
generating said second path portion comprises generating a second circulatory path associated with travel of the vehicle along the second lane, the second path portion comprising a portion of said second circulatory path;
said first boundary angle corresponds to a location of a point on said first circulatory path at which an entry path associated with a vehicle entering the roundabout along an entry lane of the roundabout intersects with said first circulatory path; and
said second boundary angle corresponds to a location of a point on said second circulatory path with respect to said origin point at which travel of a vehicle exiting the roundabout along an exit lane of the roundabout leaves the second circulatory path.

14. The method of claim 7 further comprising constraining a location of said start point such that the vehicle traveling along the lane change path would not interfere with another vehicle traveling along the second lane and exiting the roundabout at another exit lane of the roundabout disposed before the exit being used by the vehicle traveling along said lane change path.

15. The method of claim 6 wherein generating said spiral path comprises generating a plurality of spiral paths having different rates of change of radii and selecting one of said plurality of spiral paths that has a generally tangential intersection with the first path portion proximate a start point associated with the lane change and with the second path portion proximate an end point associated with the lane change.

16. The method of claim 6 wherein generating said spiral path comprises generating a plurality of spiral paths having different rates of change of radii and extending tangentially from an end point on the second path portion and selecting one of said plurality of spiral paths that intersects a line drawn tangent to the first path portion at a start point on the first path portion.

17. The method of claim 16 wherein generating said plurality of spiral paths comprises generating spiral paths by:
representing the vehicle using a design vehicle;
moving the design vehicle backwards through the roundabout from said end point on the second path portion; and
varying a steering rate of the design vehicle to generate the respective spiral paths in the plurality of spiral paths.

18. The method of claim 17 wherein varying the steering rate of the design vehicle comprises varying the steering rate over a range of steering rates associated with the design vehicle traveling through the roundabout at a design speed.

19. The method of claim 18 further comprising receiving operator input of the design speed.

20. The method of claim 6 wherein generating said vehicle path further comprises generating an exit path associated with travel of the vehicle between the second path portion and an exit lane of the roundabout.

21. The method of claim 6 wherein generating said vehicle path further comprises generating an entry path associated with travel of the vehicle between an entry lane of the roundabout and the first path portion.

22. The method of claim 2 further comprising receiving an operator selection of at least one of an entry lane, a starting lane, an ending lane, and an exit lane for the lane change.

23. The method of claim 1 wherein the central island is initially constructed as a circular central island and wherein using said vehicle extent locations to determine a geometric layout of the central island comprises using said vehicle extents to generate modifications to said circular island resulting in a non-circular island geometry.

24. The method of claim 23 wherein using said vehicle extent locations to determine a geometric layout of the central island comprises offsetting said vehicle extent locations by an offset distance to provide a clearance allowance for said vehicle travelling along the vehicle path.

25. The method of claim 1 wherein generating said vehicle path further comprises generating an exit path associated with travel of the vehicle between the vehicle path and an exit lane of the roundabout.

26. The method of claim 1 wherein generating said vehicle path further comprises generating an entry path associated with travel of the vehicle between an entry lane of the roundabout and the vehicle path.

27. The method of claim 1 wherein using said vehicle extent locations to determine said geometric layout of the central island comprises at least one of:
determining a physical curb location associated with the geometric layout of the central island;
determining a shape and extent of an extension to the central island to be indicated by marking the pavement of the roundabout; and
determining a shape and extent of an apron to facilitate passage of oversize vehicles by permitting said oversize vehicles to encroach on the apron.

28. The method of claim 1 wherein the central island is initially constructed as a circular central island and wherein using said vehicle extent locations to determine a geometric layout of the central island comprises using said vehicle extents to generate modifications to said circular island resulting in a non-circular island geometry.

29. The method of claim 28 wherein using said vehicle extent locations to determine a geometric layout of the central island comprises offsetting said vehicle extent locations by an offset distance to provide a clearance allowance for said vehicle travelling along the vehicle path.

30. The method of claim 1 further comprising:
receiving an initial geometric layout representing the traffic roundabout and central island, the initial geometric layout having been generated for a first design vehicle; and
wherein generating the vehicle path associated with travel of the vehicle through the roundabout comprises generating a vehicle path associated with travel of a second design vehicle through the roundabout, the second design vehicle requiring a reduction in the extent of the central island to facilitate passage through the roundabout.

31. The method of claim 30 wherein the first design vehicle comprises a first set of design vehicles.

32. An apparatus for facilitating computer generation of a geometric layout representing a central island of a traffic roundabout, the apparatus comprising:
means for generating a vehicle path associated with travel of a vehicle through the roundabout;
means for generating vehicle extent locations associated with travel of said vehicle along said vehicle path;
means for using said vehicle extent locations to determine a geometric layout of the central island corresponding to said vehicle extents; and
means for generating output data representing said geometric layout of the central island.

33. An apparatus for facilitating computer generation of a geometric layout representing a central island of a traffic roundabout, the apparatus comprising a processor circuit operably configured to:
generate a vehicle path associated with travel of a vehicle through the roundabout;
generate vehicle extent locations associated with travel of said vehicle along said vehicle path;
use said vehicle extent locations to determine a geometric layout of the central island corresponding to said vehicle extents; and
generate output data representing said geometric layout of the central island.

34. A computer readable medium encoded with codes for directing a processor circuit to facilitate computer generation of a geometric layout representing a central island of a traffic roundabout, the computer readable medium including codes for:
generating a vehicle path associated with travel of a vehicle through the roundabout;
generating vehicle extent locations associated with travel of said vehicle along said vehicle path;
using said vehicle extent locations to determine a geometric layout of the central island corresponding to said vehicle extents; and
generating output data representing said geometric layout of the central island.
